(19) United States
(12) Patent Application Publication
(10) Pub. No.: US 2026/0349893 A1
(43) Pub. Date: Nov. 5, 2026

(54) BASIC INPUT/OUTPUT SYSTEM (BIOS) CONFIGURATION MANAGEMENT IN A SERVICEABILITY FRAMEWORK

(71) Applicant: Dell Products L.P., Round Rock, TX (US)

(72) Inventors: Ibrahim Sayyed, Georgetown, TX (US); Karunakar Palicherla Reddy, Austin, TX (US); Balasingh P. Samuel, Round Rock, TX (US)

(73) Assignee: Dell Products L.P., Round Rock, TX (US)

(21) Appl. No.: 19/199,148

(22) Filed: May 5, 2025

(51) Int. Cl. G06F 11/30

(52) U.S. Cl. CPC G06F 11/3041

(57) ABSTRACT

Systems and methods for Basic Input/Output Configuration Management (BIOS) management in a serviceability framework are described. In an illustrative, non-limiting embodiment, an Information Handling System (IHS) may include a controller having firmware that, upon execution by a processing core, causes the processing core to instantiate an orchestrator of a serviceability framework; and a plurality of devices coupled to the controller, where each device of the plurality of devices comprises firmware that, upon execution by a corresponding processing core, causes the corresponding processing core to produce a node coupled to the orchestrator via the serviceability framework, and where the orchestrator is configured to: detect an event; and in response to the detection, provide a notification to a Basic Input/Output System (BIOS), where the BIOS is configured to restrict a change to a BIOS configuration setting in response to the notification.

### FIELD

This disclosure relates generally to Information Handling Systems (IHSs), and more specifically, to systems and methods for Basic Input/Output Configuration Management (BIOS) management in a serviceability framework.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

In today's landscape, the demand for intelligent and contextually aware IHSs is increasing. Modern IHSs are expected to adapt seamlessly to their users' environments and needs. This expectation has led to the integration of various technologies aimed at enhancing user experience and efficiency. However, despite advancements, many contemporary IHSs still fall short in providing comprehensive contextual awareness.

Consequently, as the inventors hereof have recognized, IHSs continue to face challenges like inefficient power management, inadequate environmental sensing, and limited user interaction capabilities. These challenges often lead to reduced performance, increased energy consumption, and a less intuitive user experience. As users increasingly depend on their IHSs for both personal and professional tasks, the inventors have identified an increasing demand for systems that can intelligently manage resources and anticipate user requirements.

### SUMMARY

Systems and methods for Basic Input/Output Configuration Management (BIOS) management in a serviceability framework are described. In an illustrative, non-limiting embodiment, an Information Handling System (IHS) may include a controller having firmware that, upon execution by a processing core, causes the processing core to instantiate an orchestrator of a serviceability framework; and a plurality of devices coupled to the controller, where each device of the plurality of devices comprises firmware that, upon execution by a corresponding processing core, causes the corresponding processing core to produce a node coupled to the orchestrator via the serviceability framework, and where the orchestrator is configured to: detect an event; and in response to the detection, provide a notification to a Basic Input/Output System (BIOS), where the BIOS is configured to restrict a change to a BIOS configuration setting in response to the notification.

The controller may include an Embedded Controller (EC) or Baseband Management Controller (BMC). The plurality of devices may include at least one of: a sensor, a sensor hub, a Central Processing Unit (CPU), a Graphical Processing Unit (GPU), an audio Digital Signal Processor (aDSP), a Neural Processing Unit (NPU), a Tensor Processing Unit (TPU), a Neural Network Processor (NNP), an Intelligence Processing Unit (IPU), an Image Signal Processor (ISP), a Video Processing Unit (VPU), a camera controller, an audio controller, a memory, a Universal Serial Bus (USB) device, a Peripheral Component Interconnect express (PCIe) device, or a Trusted Platform Module (TPM).

At least one of the plurality of devices may be coupled to the controller via at least one of: a Systems-on-Chip (SoC) interconnect, a Peripheral Component Interconnect express (PCIe) bus, or a Universal Serial Bus (USB) port. The SoC interconnect may include at least one of: an Advanced Microcontroller Bus Architecture (AMBA) bus, a QuickPath Interconnect (QPI) bus, or a HyperTransport (HT) bus.

For example, the event may include at least one of: an environmental condition, a physical impact, a state change, a hardware or sensor failure, a power or battery-related condition, a security issue, or a user interaction. The environmental condition may include at least one of: ambient temperature, humidity, moisture, air quality, dust accumulation, or light level. The state change may indicate at least one of: in-bag detection, geographic location change, high system usage, motion or vibration detection, power state transition, peripheral or port change, or posture change.

The battery-related condition may indicate at least one of: low battery level, overcurrent protection activation, battery charge cycle count, battery state of health, battery temperature, or a transition between power sources. The security issue may indicate at least one of: detection of unauthorized BIOS access, detection of an unmanaged software installation or update, or an attempt to access restricted ports or peripherals. To detect the event, the orchestrator may be configured to evaluate telemetry or contextual data from at least one of: a sensor or a sensor hub, among the plurality of devices via the serviceability framework.

The orchestrator may be configured to provide the notification while a host OS of the IHSis: in a sleep state, in a standby state, corrupted, inoperable, or absent. The orchestrator may also be configured to provide the notification based, at least in part, upon enforcement of a BIOS management policy.

The BIOS management policy may include one or more context-based rules that enable the orchestrator to determine whether to provide the notification based, at least in part, upon contextual data. Additionally, or alternatively, the BIOS management policy may include one or more context-based rules that enable the orchestrator to include in the notification a selection of a BIOS configuration setting to be protected based, at least in part, upon the event.

Additionally, or alternatively, the BIOS management policy may include one or more context-based rules that enable the orchestrator to include in the notification a selection of a BIOS configuration setting to be protected based, at least in part, upon contextual information. The contextual information may include at least one of: user presence or geographic location.

The orchestrator may be configured to: determine a health metric of the IHS; and in response the determination, provide another notification to the BIOS to allow changes to the configuration setting. In another illustrative, non-limiting embodiment, a method may include: receiving a notification at a BIOS from an EC of an IHS; and, in response to the notification, restricting a user's ability to change to a BIOS configuration setting.

In yet another illustrative, non-limiting embodiment, an EC may be integrated into or coupled to a heterogeneous computing platform of an IHS, the EC including: a processing core distinct from any host processor of the heterogeneous computing platform; and a memory coupled to the processing core, the memory having firmware instructions stored thereon that, upon execution by the processing core, cause the EC to provide a notification to a BIOS in response to an event, wherein the BIOS is configured to restrict a change to a BIOS configuration setting in response to the notification.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram of examples of components of an Information Handling System (IHS), according to some embodiments.

FIG. 2 is a diagram of an example of a heterogenous computing platform, according to some embodiments.

FIG. 3 is a diagram of a node in a serviceability framework, according to some embodiments.

FIG. 4 is a diagram of an example of hierarchical orchestration in a serviceability framework, according to some embodiments.

FIG. 5 is a diagram of examples of orchestration services in a serviceability framework, according to some embodiments.

FIG. 6 is a flowchart of an example of a method for operating a serviceability framework, according to some embodiments.

FIG. 7 is a diagram of an example of a contextual intelligence system, according to some embodiments.

FIG. 8 is a flowchart illustrating an example of a method for Basic Input/Output Configuration Management (BIOS) management, according to some embodiments.

FIG. 9 is a flowchart illustrating an example of another method for BIOS management, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

Historically, IHSs with desktop and laptop form factors have relied on conventional host Operating Systems (OSs) such as WINDOWS, LINUX, and MAC OS, executed on INTEL or AMD's “x86”-type processors. In contrast, ARM processors have been predominantly used in smartphones and tablet devices, running thinner, simpler, or mobile OSs like ANDROID, iOS, and WINDOWS MOBILE. Recently, however, IHS manufacturers have begun shipping full-fledged desktop and laptop IHSs equipped with ARM-based platforms, and some OSs, such as WINDOWS on ARM, have been developed to provide users with more quintessential OS experiences on those platforms. As such, IHSs may now include any number of processors, controllers, sensors, and other devices, each configured to execute its own firmware.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG'S EXYNOS, APPLE'S “A” SERIES, etc.

The term “firmware,” as used herein, refers to a class of program instructions that provides low-level control for a device's hardware. Firmware enables basic functions of a device and/or provides hardware abstraction services to higher-level software, such as an OS. The term “firmware installation package,” as used herein, refers to program instructions that, upon execution, deploy device drivers or services in an IHS or IHS component.

The term “device driver” or “driver,” as used herein, refers to program instructions that operate or control a particular type of device. A driver provides a software interface to hardware devices, enabling an OS and other applications to access hardware functions without needing to know precise details about the hardware being used. When an application invokes a routine in a driver, the driver issues commands to a corresponding device. Once the device sends data back to the driver, the driver may invoke certain routines in the application. Generally, device drivers are hardware dependent and OS-specific.

The term “telemetry data,” as used herein, refers to information resulting from the in situ collection of measurements or other data by devices within a heterogeneous computing platform, or any other IHS device or component. Telemetry data typically includes, but is not limited to, measurements, metrics, and values indicative of core utilization, memory utilization, CPU performance state, network quality, utilization, bandwidth, throughput, battery charging or state data, peripheral or I/O device utilization, temperature, location, acceleration, and power state. It also encompasses logs and other information related to transaction times, latencies, response codes, and errors.

Meanwhile, the term “contextual data” refers to information that provides a broader understanding of the environment and circumstances surrounding an IHS's operation. It may include information produced by a variety of sensors usable to ascertain environmental conditions such as ambient temperature and humidity, motion and orientation data from accelerometers and gyroscopes, and air quality metrics from particle sensors. User proximity information may be gathered from technologies like ultrasound, WiFi Doppler, RF radar, or UWB sensors. This data includes qualitative aspects such as user presence, attention, movement, or mode of use, which help the IHS adapt its behavior to the user's needs and the surrounding environment.

Contextual and telemetry data may enable the IHS to make intelligent decisions, enhancing user experience and efficiency. For example, user presence illustrates the relationship between the two. As telemetry data, user presence involves the collection of quantitative metrics, such as proximity or engagement levels, which may be used for monitoring and diagnostic purposes. As contextual data, user presence provides qualitative insights into the user's interaction with the IHS, allowing it to adapt its operations to enhance user experience, such as adjusting power settings or securing information when the user is absent. Together, telemetry and contextual data provide a comprehensive view of both the technical and environmental context of the IHS.

As used herein, the term “Artificial Intelligence (AI) model” generally refers to a computational algorithm designed to simulate intelligent behavior by processing and analyzing data to make predictions, decisions, or classifications. These models are typically trained using large datasets to recognize patterns and learn from examples, enabling them to perform tasks such as image recognition, natural language processing, and predictive analytics. AI models may be implemented in various forms, including machine learning models, which learn from data to improve their performance over time, and neural networks. Deep learning models, a subset of neural networks with multiple layers, are used for advanced applications like autonomous driving and real-time language translation. Natural Language Processing (NLP) models are specialized AI models designed to understand and generate human language, enabling applications such as chatbots and sentiment analysis. Predictive models analyze historical data to forecast future outcomes, aiding in decision-making processes across various domains.

Particularly, AI models may be employed to process telemetry and contextual data, enabling the IHS to make intelligent decisions based on real-time information. This may include adjusting system settings, optimizing performance, and implementing self-healing and remediation strategies to enhance user experience and system reliability. These AI models may be executed by any processor or controller within the IHS, but they may also be run on dedicated AI accelerators or GPUs, which are specifically designed to handle the intensive computational demands of AI tasks, thereby enhancing the efficiency and speed of processing.

In various embodiments, the systems and methods described herein integrate a comprehensive array of sensors and AI-driven algorithms to create a contextually aware IHS environment that enhances user experience, performance, and sustainability. By leveraging telemetry and contextual data obtained from motion sensors, ambient light sensors, camera sensors, microphones, pressure sensors, air particle sensors, and external temperature and humidity sensors, these systems and methods can intelligently detect user presence, environmental conditions, and device usage patterns. This capability enables proactive adjustments to IHS settings, such as display brightness, audio responsiveness, and power management, based on real-time context. Furthermore, these systems and methods also introduce self-healing and remediation techniques that automatically detect and resolve IHS issues, thereby improving reliability and reducing maintenance costs—often without requiring user intervention.

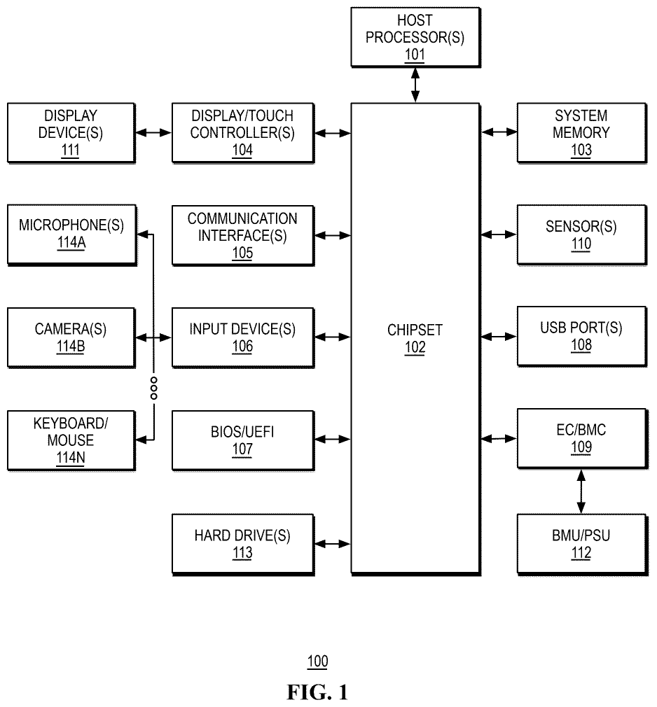

To illustrate this, FIG. 1 is a block diagram of components of IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as Ethernet, WiFi, BT, cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, microphones, headsets, etc.). Moreover, communication interface(s) 105 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provides video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be provided as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 108, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 113.

Chipset 102 may also provide access to one or more input devices 106, for example, using a super I/O controller or the like. Examples of input devices 106 include, but are not limited to, microphone(s) 114A, camera(s) 114B, and keyboard/mouse 114N. Other input devices 106 may include a touchpad, stylus or active pen, totem, etc. Each input device 106 may include a respective controller (e.g., a touchpad may have its own touchpad controller) that interfaces with chipset 102 through a wired or wireless connection (e.g., via communication interfaces(s) 105).

In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensors 110 may be disposed on or within the chassis of IHS 100, or otherwise coupled to IHS 100, and may include, but are not limited to: electric, magnetic (including magnetometer), radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), acceleration, ambient light, air particle, external temperature, and humidity sensors, among others.

BIOS 107 is coupled to chipset 102. UEFI was designed as a successor to BIOS, and many modern IHSs utilize UEFI in addition to or instead of a BIOS. Accordingly, BIOS 107 is intended to also encompass a UEFI component. BIOS 107 provides an abstraction layer that allows the OS to interface with certain hardware components that are utilized by IHS 100.

Upon booting of IHS 100, host processor(s) 101 may utilize program instructions of BIOS 107 to initialize and test hardware components coupled to IHS 100, and to load a host OS for use by IHS 100. Via the hardware abstraction layer provided by BIOS 107, software stored in system memory 103 and executed by host processor(s) 101 can interface with I/O devices coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101.

Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote or Out-of-Band (OOB) management, diagnostics, and remediation over network(s) 103, etc.

Unlike other devices in IHS 100, EC 109 may be made operational from the very start of each power reset, before other devices are fully running or powered on. As such, EC 109 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

Furthermore, EC 109 may also have direct access to General Purpose Input/Output (GPIO) interfaces, allowing it to communicate directly with sensors 110 and other devices. This access enables EC 109 to reset devices, control power states, and manage power rails, so that devices may be powered on or off as needed. This capability allows EC 109 to perform critical operations such as isolating faulty components, managing power distribution, and ensuring optimal device performance across various operational states. Within IHS 100, the EC's hardware and firmware access typically extend beyond what the host OS and BIOS can achieve, enabling it to execute low-level operations and manage hardware components directly.

In some cases, EC 109 may implement operations for detecting certain changes to the physical configuration or posture of IHS 100 and managing other devices in different configurations of IHS 100. For instance, when IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

EC 109 may also be installed as a Trusted Execution Environment (TEE) component to the motherboard of IHS 100. Additionally, or alternatively, EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate the hash value for a component, and it may compare it against the reference hash value to determine if any modifications have been made to the component, thus indicating that the component has been compromised. As such, EC 109 may validate the integrity of hardware and software components installed in IHS 100.

In addition, EC 109 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an Alternating Current (AC) adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries).

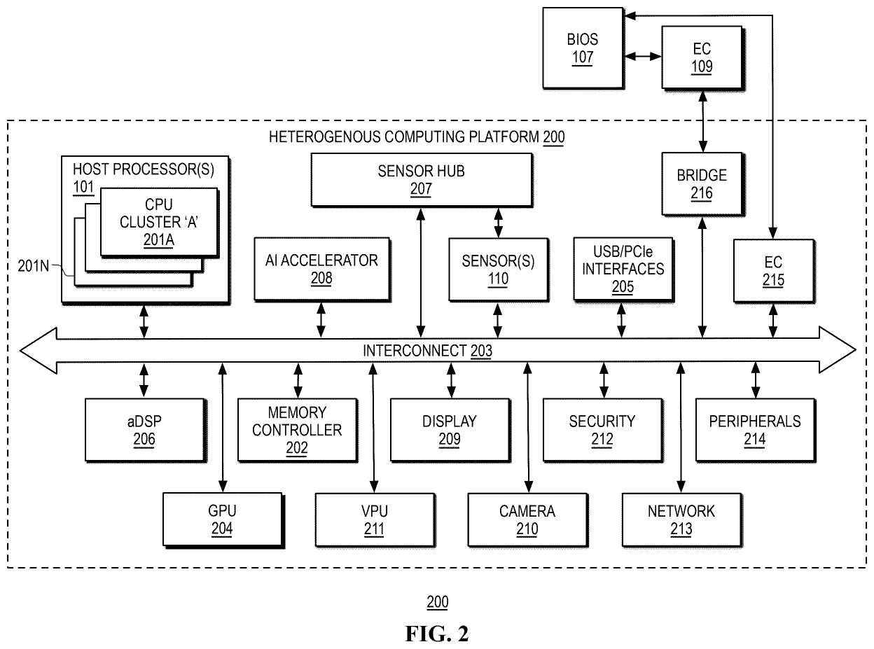

Battery Management Unit (BMU) and/or Power Supply Unit (PSU) 112 may be coupled to EC 109. BMU/PSU 112 may include an Analog Front End (AFE), storage (e.g., non-volatile memory), and a microcontroller. In some implementations, the microcontroller may enable monitoring and management capabilities, allowing it to regulate charging and power delivery, track power consumption metrics, and communicate relevant power-related data to other devices such as, for example, components of heterogeneous computing platform 200 in FIG. 2. Although not explicitly shown as coupled to all components, BMU/PSU 112 typically provides power to devices within IHS 100.

In operation, examples of telemetry data collectible by a BMU may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), detected events, etc.

Meanwhile, BMU-detected events may include, but are not limited to: acceleration or shock events, transportation events, exposure to elevated temperature for extended time periods, high discharge current rate, combinations of battery voltage, battery current, and/or battery temperature (e.g., elevated temperature event at full charge and/or high voltage causes more battery degradation than lower voltage), etc.

Similarly, a PSU may collect and store operational data such as input and output power levels, power efficiency metrics, power rail voltage levels, transient response characteristics, power ripple, thermal performance, and fault conditions (e.g., overvoltage, undervoltage, overcurrent, short circuit protection events). A PSU may also track power source transitions, such as switching between AC and DC sources, record historical power usage patterns to assist in predictive maintenance and energy efficiency optimizations, and detect and log events such as: power surges, transient voltage fluctuations, thermal shutdown events, power supply unit failures, abnormal current draws, external power interruptions, load balancing adjustments, etc.

A PSU may further detect and log anomalies such as excessive power draw by specific components, prolonged high-power states that may indicate inefficiencies, and interactions between different power rails that may impact IHS stability. In some implementations, a PSU may communicate with a BMU within the same IHS 100 to coordinate power delivery strategies, to support transitions between battery and external power sources.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components shown in FIG. 1 (e.g., chipset 102, display controller(s) 104, communication interface(s) 105, EC 109, etc.) may be replaced by devices within heterogenous computing platform 200 (FIG. 2). As such, IHS 100 may assume different form factors including, but not limited to: servers, workstations, desktops, laptops, appliances, video game consoles, tablets, smartphones, etc.

FIG. 2 is a diagram illustrating an example of heterogenous computing platform 200. In various embodiments, heterogenous computing platform 200 may be implemented in an SoC, Field-Programmable Gate Array (FPGA), Application-Specific Integrated Circuit (ASIC), or the like. Heterogenous computing platform 200 includes a plurality of discrete or segregated devices or components, each device having a different set of processing capabilities suitable for handling a particular type of computational task. When each device in platform 200 executes only the types of computational tasks it is specifically designed to execute, the overall power consumption of heterogenous computing platform 200 is reduced.

In comparison to the architecture depicted in FIG. 1, where chipset 102 serves as a central hub for communication and resource management, heterogenous computing platform 200 illustrates a more distributed approach. Here, the chipset's role is transformed, with each device and/or sensor in platform 200 potentially having its own processing capabilities and firmware, allowing for more efficient and specialized task execution.

Particularly, each device and/or sensor in heterogenous computing platform 200 may include its own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device and/or sensor in heterogenous computing platform 200 may execute its own firmware, and it may be accessible through a respective Application Programming Interface (API). Additionally, or alternatively, each device and/or sensor in heterogenous computing platform 200 may execute its own OS. Additionally, or alternatively, one or more of these devices may be a virtual device.

In FIG. 2, heterogenous computing platform 200 includes CPU clusters 201A-N as a particular implementation of host processor(s) 101 intended to perform general-purpose computing operations. Each of CPU clusters 201A-N may include one or more processing core(s) and cache memor(ies). In operation, CPU clusters 201A-N are available and accessible to the IHS's host OS (e.g., WINDOWS on ARM), host OS application(s), OS agent(s), and other application(s) 314 executed by IHS 100.

CPU clusters 201A-N are coupled to memory controller 202 via internal interconnect fabric 203. Memory controller 202 is responsible for managing memory accesses for all of devices connected to interconnect 203, which may include any communication bus suitable for inter-device communications within an SoC (e.g., Advanced Microcontroller Bus Architecture or “AMBA,” QuickPath Interconnect or “QPI,” HyperTransport or “HT,” etc.).

Devices coupled to interconnect 203 may communicate with each other and/or with a host OS executed by CPU clusters 201A-N. In various embodiments, one or more devices (e.g., GPU 204, aDSP 206, sensor hub 207, AI accelerator 208, VPU 211, etc.) may be configured to execute one or more AI model(s), simulation(s), and/or inference(s). In some cases, one of these devices and/or sensors may be coupled to interconnect 203 via a secondary interconnect fabric (not shown). Such secondary interconnect fabric may include any bus suitable for inter-device and/or inter-bus communications within a SoC.

For example, GPU 204 is a device designed to produce graphical or visual content and to communicate that content to a monitor or display, where the content may be rendered. USB/PCIe interfaces 205 provide an entry point into any additional devices external to heterogenous computing platform 200 that have a respective USB/PCIe interface (e.g., docking station, graphics adapter, Type-C USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc.

In operation, input and/or output audio streams may pass through and be processed by aDSP 206, which may send the processed audio to other devices on internal interconnect fabric 203 (e.g., CPU clusters 201A-N). Also, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.). To that end, aDSP 206 may be coupled to BMU/PSU 112.

Sensor hub and integrated AI accelerator 207 is a very low power, always-on device designed to consolidate information received from other devices in heterogenous computing platform 200, process any context and/or telemetry data streams, and provide that information to: (i) a host OS, (ii) other applications, and/or (iii) other devices in platform 200. For example, sensor hub and integrated AI accelerator 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.).

Sensor hub 207 may include an always-on, low-power core configured to execute AI models, whose inferences provide a foundation for contextual awareness and other enhancements. In some embodiments, sensor hub 207 may be configured to function as an orchestrator (or a secondary orchestrator), responsible for managing other devices, such as sensors 110, based on a policy or the like.

AI accelerator 208 is a more computationally powerful processing device than sensor hub 207, and it may be designed to execute multiple complex AI algorithms and models concurrently (e.g., NLP, speech recognition, speech-to-text transcription, video processing, gesture recognition, user engagement determinations, etc.). For example, AI accelerator 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks.

Display/graphics device 209 is designed to perform additional video enhancement operations. In operation, display/graphics device 209 may provide a video signal to an external display coupled to IHS 100 (e.g., display device(s) 111).

Camera device 210 includes an Image Signal Processor (ISP) configured to receive and process video frames captured by a camera coupled to heterogenous computing platform 200 (e.g., in the visible and/or infrared spectrum).

Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Security device 212 includes any suitable security device, such as a dedicated security processor, a Trusted Platform Module (TPM), a TRUSTZONE device, a PLUTON processor, or the like. In various implementations, security device 212 may be used to perform cryptography operations (e.g., generation of cryptographic key pairs, validation of digital certificates, etc.) and/or it may serve as a hardware root-of-trust (RoT) for heterogenous computing platform 200 and/or IHS 100.

Network controller 213 is a device designed to enable wired (e.g., Ethernet) and/or wireless communications in any suitable frequency band (e.g., BLUETOOTH or “BT,” WiFi, CDMA, 5G, satellite, etc.), subject to AI-powered optimizations/customizations for improved speeds, reliability, and/or coverage.

Peripherals 214 may include any device coupled to heterogenous computing platform 200 (e.g., sensors 110) through mechanisms other than USB/PCIe interfaces 205. In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100.

In various implementations, EC 215 may be integrated into heterogenous computing platform 200 of IHS 100. In other implementations, EC 109 may be completely external to platform 200 (i.e., it may reside in its own semiconductor package) but coupled to integrated bridge 216 via an interface (e.g., enhanced SPI or “eSPI”) to provide or maintain the EC's ability to access the SoC's interconnect 203, including sensor hub 207 and sensor(s) 110, and to allow EC 109 to access and/or run most or all of devices directly. As shown, EC 109/215 may have access to BIOS 107. Moreover, in each of these scenarios, EC 109/215 may be configured to operate as an orchestrator instead of (or along with, for example as a primary orchestrator) sensor hub 207.

In some embodiments, heterogeneous computing platform 200 may not include all the devices shown in FIG. 2. In other embodiments, heterogeneous computing platform 200 may include other devices in addition to those that are shown in FIG. 2. Furthermore, some devices that are represented as separate components in FIG. 2 may instead be integrated with other devices, such that all or a portion of the operations executed by the illustrated devices may instead be executed by the integrated device.

As the inventors hereof have recognized, the increasing complexity of user environments and the demand for seamless integration of diverse technologies are creating challenges for IHSs to adapt efficiently. These challenges are compounded by the need for systems to provide better user experience while maintaining high levels of performance and energy efficiency. Current solutions often fall short in dynamically adjusting to environmental changes and user interactions, leading to inefficiencies and potential security vulnerabilities.

To address these challenges, a serviceability framework is introduced. In various embodiments, the framework may leverages a comprehensive array of sensors and AI models to create a contextually aware environment, enabling intelligent detection of user presence, environmental conditions, and device usage patterns. These allow for proactive adjustments to system settings, such as display brightness, audio responsiveness, and power management, while also implementing self-healing and remediation techniques to improve reliability and reduce maintenance costs without user intervention.

In various implementations a serviceability framework may include an orchestrator, a central component responsible for managing and coordinating the operations of all participating devices and sensors. Each device or sensor that joins the framework instantiates a node, actively participating in the firmware environment. The orchestrator facilitates seamless communication between nodes, enabling real-time adjustments to system settings and optimizing performance for a responsive user experience.

The orchestrator may enforce policies for configuring and managing the framework's operations. These policies cover various aspects, including device and capability discovery, interface management, security protocols, telemetry collection, power and performance management, etc. By enforcing these policies, the orchestrator may implement actions and behaviors according to the requirements set by users, OEMs, Information Technology Decision Makers (ITDMs), or third parties. The orchestrator may perform advertising, discovering, and configuring devices, collecting and processing telemetry data, updating firmware, controlling power states and performance levels, and executing AI models. It may also enforce secure communications within the framework through data encryption, authentication, and verification processes.

In some cases, the orchestrator may serve as a Root-of-Trust (RoT) for the framework, while nodes provide capabilities deployed within it. For example, EC 109/215 may implement the orchestrator, while sensor hub 207 or other sensors 110 may implement nodes. Once the orchestrator executes its firmware, it instantiates the serviceability framework, which other nodes can join. The framework provides secure communication paths for all firmware communications within the IHS and can extend to secondary IHSs or peripheral devices. It offers scalable discoverability and communication pathways without OS dependencies, reducing the need for custom integration designs by OEMs.

The serviceability framework may support communication across disparate devices using standard protocols and implement reusable runtime modules. Certain capabilities, such as discovery, security, and status, may be standardized across different types of IHSs in a hardware and OS-agnostic manner. Various consumers, including a host OS, secondary IHS, and remote services, may access the framework directly through the orchestrator, communicating in-band, sideband, or out-of-band (OOB) to issue commands, collect telemetry, update firmware, and more.

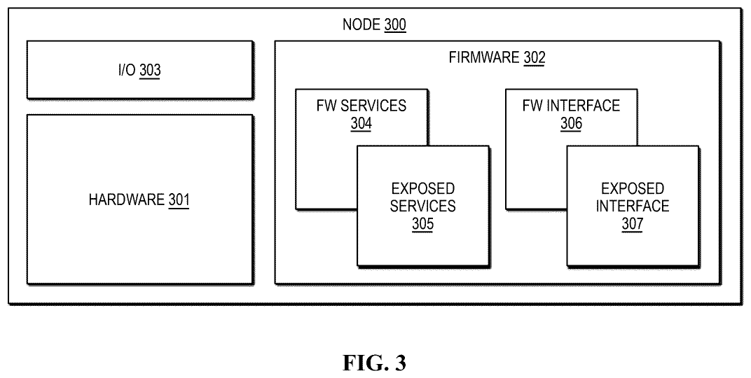

FIG. 3 is a diagram of a device within operating as a node in a serviceability framework, according to some embodiments. In implementations where a single or monolithic piece of hardware (e.g., a chip) includes or otherwise operates as two or more nodes, components of node 302/300 may be apportioned or split between two or more “virtual devices,” each virtual device corresponding to a respective node. In other implementations, however, two or more discrete pieces of hardware may operate together to form a single framework node.

As shown, node 300 includes hardware 301, firmware 302, and I/O 300. Specifically, hardware 301 may include a chip, a processor, a controller, a processing core, or any suitable circuit configured to execute the operations provided by node 300, and it may also include a memory and other components. Hardware 301 may be configured to execute firmware instructions or code 302, and to thereby produce one or more components and/or features of a serviceability framework. Meanwhile, I/O 300 may include any suitable port or connection responsible for communications to and from another node, including messages and data exchanged as part of the serviceability framework.

Firmware instructions 302, upon execution by hardware 301, may produce firmware services 304 and firmware interface 306. Firmware services 304 may include functions or operations that run on, or can be executed by, node 300 to enable it to participate in the serviceability framework as an orchestrator 401 and/or any of node. These operations may include exclusive OEM and/or device manufacturer features such as, for example: sensor handling, telemetry collection, presence detection, shock detection, AI models, routines, etc. In many cases, these features may be host OS-independent and/or agnostic. Exposed services 305 may include a subset of firmware services 304 (and/or other services) responsible for executing functions and operations advertised or exposed to the serviceability framework, including orchestration services (discovery, capability, telemetry, security, etc.) and node services.

Firmware interface 306 provides an interface layer that includes methods, functions, and operations configured to enable internal and external communications into or from node 300 that reach into (and/or out of) firmware services 304 and/or exposed services 305. Exposed interface 307 (e.g., APIs) may include a subset of firmware interface 306 (and/or other services) responsible for connecting to and supporting framework-specific interfaces, as well as for translating commands across standard communication interfaces, to/from a device's lower layer(s) to the serviceability framework.

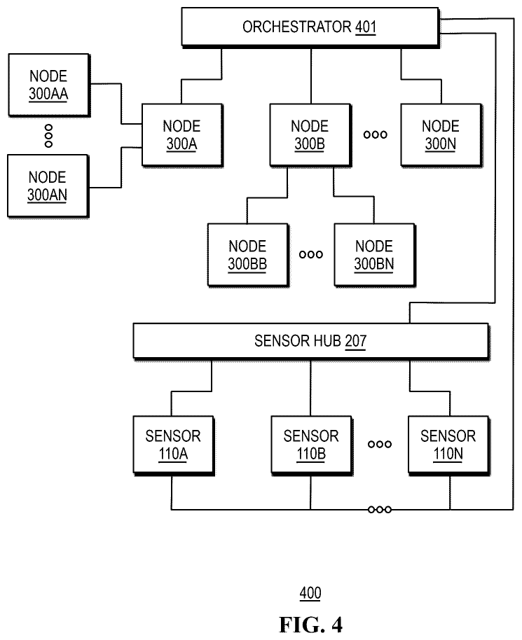

FIG. 4 is a diagram of an example of hierarchical orchestration in serviceability framework 400. It should be noted that, in general, serviceability framework 400 may be application, use, and/or context specific, therefore this example is provided for sake of illustration only, and multiple variations are envisioned.

In this example, orchestrator 401 may be implemented by EC 109/215 and coupled to nodes 300A-N (implemented by any other IHS device). External nodes 300AA-AN (outside of the IHS's chassis) may be coupled to node 300A, such that node 300A is a parent node (“upstream”) with respect to external nodes 300AA-AN (“downstream”)—conversely, external nodes 300AA-AN are child nodes with respect to node 300A. Connections, buses, interconnects, and communication protocols between orchestrator 401, nodes 300A, and/or nodes 300AA-AN, may follow any suitable standard. For example, in some cases, a USB controller (e.g., USB/PCIe interface 205) may implement node 300A, and any external USB device coupled to node 300A via a USB port may implement any of nodes 300AA-AN.

Nodes 300BB-BN are coupled to node 300B, such that node 300B (an “upstream” node) is a parent node with respect to nodes 300BB-BN (a “downstream” node), and nodes 300BB-BN are child nodes with respect to node 300B. In some cases, for example, sensor hub 207 may implement node 300B, and nodes 300BB-AN may represent any internal device or sensor(s) 110 coupled to node 300B.

In the embodiment of the serviceability framework depicted here, orchestrator 401 is coupled to sensor hub 207 as well as to sensors 110A-N, utilizing connections such as a communication bus, GPIO connection, or power rail. In other implementations, however, sensor hub 207 may be replaced with a docking station, hub, or display that includes its own EC, similar to EC 109/215.

In operation, orchestrator 401 may aggregate interfaces and capabilities reflective of nodes 300A-N and their respective child nodes (e.g., nodes 300AA-AN and/or 300BB-BN), whereas secondary orchestrator 402 may aggregate interfaces and capabilities reflective of sensors 110A-N. Parent nodes 300A and 300B may also serve as aggregators; however, in some cases, they may be bypassed by orchestrator 401 when managing child nodes 300AA-AN and 300BB-BN directly.

Orchestrator 401 may also serve as “primary orchestrator” within serviceability framework 400. Particularly, orchestrator 401 may manage the operations of sensor hub 402, thereby extending the number of devices participating in firmware framework 307, exposing their interfaces and capabilities, delegating (or being delegated) certain tasks, etc. For example, sensor hub 207 may work as “secondary orchestrator” to perform discovery operations with respect to sensors 110A-N, and it may report its own inventory and/or manifest (of child devices, capabilities, and/or interfaces) to orchestrator 401 for addition and/or removal of devices and sensors to/from serviceability framework 400.

Sensor hub 207 is coupled to sensors 110A-N, here shown as integrated or internal to peripheral device 401. In other applications, however, one or more sensors 110A-N may be external to IHS 100. Any node external to IHS 100, including nodes 300AA-AN, may be added to or removed while IHS 100 is operating, such that orchestrator 401 may adjust serviceability framework 400 on demand, refreshing or updating the framework's capabilities, interfaces, etc., as components are swapped in and out.

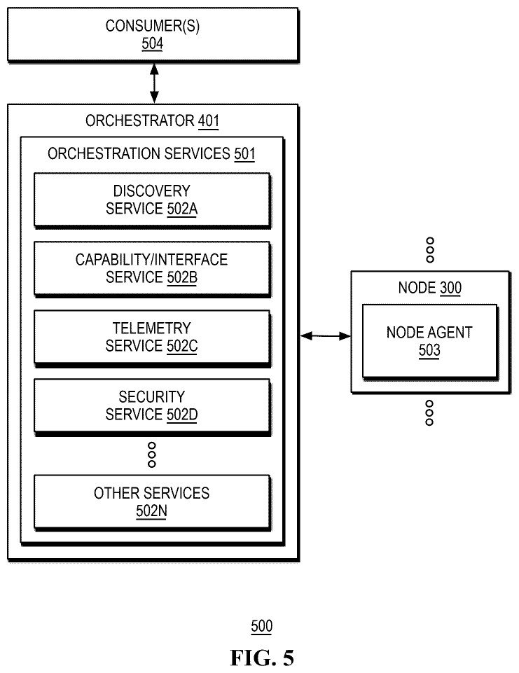

FIG. 5 is a diagram of examples of orchestration services in portion 500 of serviceability framework 400. In this embodiment, upon execution of its firmware 302 to instantiate firmware services 304 and/or exposed services 305, orchestrator 401 (instantiated by EC 109/215) may provide orchestration services 601 such as: discovery service 502A, capability/interface service 502B, telemetry service 502C, security service 502D, and other services or agents 502N.

Conversely, upon execution of its firmware 302 to instantiate firmware services 304 and/or exposed services 305, node 300 may provide node agent or service 503 configured to communicate with orchestration services 501 to send and receive control and/or data messages within serviceability framework 400.

For example, discovery service 502A of orchestration services 501 may communicate with node agent or service 503 to perform one or more discovery operations (e.g., device, capabilities, interfaces, etc.). Capability/interface service 502B may communicate with node agents 503 to perform one or more capability/interface handling operations (e.g., consolidation of capabilities in a common namespace, advertisement, access control, etc.). Telemetry service 502C may communicate with node agent or service 503 to perform one or more telemetry collection, aggregation, or processing operations. Security service 502D may communicate with node agent or service 503 to perform one or more security operations.

Once serviceability framework 400 is established, consumer(s) 504 may access orchestration services 501 directly through orchestrator 401, without relying on any host OS of IHS 100. Unless configured to receive or transmit private communications with certain nodes that are intended to bypass orchestrator 401, consumer(s) 504 may ordinarily access any node agent or service 503 through orchestration services 501. Conversely, node agents or services 503 may access consumer(s) 504 through orchestration services 501.

In some cases, discovery service 502A may identify which orchestrators and nodes may join and become part of serviceability framework 400. Discovery service 502A may also produce a manifest of all participating orchestrators and nodes, with identification details (e.g., serial number, type of device implementing a given node, etc.) as well as their available capabilities and interfaces. The firmware framework manifest may also indicate hierarchical relationships or architectural topologies between orchestrators and nodes.

Discovery service 502A may be configured to communicate with all nodes via scaled interfaces (e.g., I²C, SPI, I³C, etc.) between orchestrator 401 and those nodes. Meanwhile, each node 300 may execute its own firmware to instantiate its own node agent or service 503. Node agent 503 may be configured to operate in conjunction with discovery service 502A, for example, by responding to requests (or by broadcasting its own discovery messages) to enable orchestrator 401 to enumerate and advertise its capabilities and interfaces.

Discovery service 502A may be responsible for device communication and querying of system states to node services or agent 503. In some cases, node services or agent 503 may broadcast node information to discovery service 502A via exposed interface 507. Additionally, or alternatively, discovery service 502A may issue discovery requests to node services or agent 503, and it may receive discovery responses from it, also via exposed interface 507.

Discovery responses by a node service or agent 503 may include, but are not limited to: an identifier, a serial number, a service tag, a type of device, capabilities (e.g., functions, operations, transactions, calls, etc., that the device is configured to perform), interfaces (for accessing the capabilities), etc. In some cases, node information provided by a parent node may also include node information of child nodes downstream from the parent node.

Discovery service 502A may consolidate discovery responses from all node services or agents 503 of all nodes, and it may assemble them to produce a manifest or inventory of all connected devices and available capabilities within serviceability framework 400 (e.g., a “device tree”). This manifest or inventory and associated data may be stored in and/or handled by orchestrator 401.

In some cases, discovery service 502A may enforce a policy. The policy may be expressed in any suitable format (e.g., Extensible Markup Language or “XML,” JavaScript Object Notation or “JSON,” etc.), and it may include rules for discovering devices and/or types of devices (e.g., orchestrators or nodes). Policy rules may prescribe, for example, whether a discovery process should happen by polling or broadcast, a polling order or method, a choice of selected one of a plurality of available communication buses or protocols for discovery messages, etc.

In some cases, such a policy may be provided by an OEM or ITDM, and/or may be selected by a user of IHS 100. Moreover, these rules may be context-based (e.g., different rules may apply depending, for example, upon the IHS's power state, battery charge, whether the IHS is moving, a location of the IHS, user's proximity or distance to the IHS, a time of day, weather conditions, bag or lid state, IHS posture or form factor, calendar information of a user of the IHS, or any other contextual information or state described herein).

Node agent 503 may communicate with discovery service 502A via a protocol or bus, which may be selected dynamically and/or by policy. Node agent 503 may transmit messages indicating its exposed capabilities and interfaces to discovery service 502A, as well as any connected and/or available child nodes and their configurations, for example, using any suitable advertisement method. In cases where orchestrator 401 discovers sensor hub 207 (or vice-versa), sensor hub 207 may have its own discovery services, which may communicate with each other similarly as discovery service 502A and node agent 503.

In some implementations, communications sent to or from node agent 503 may be in a package that presents a full list of device information, capabilities, interfaces, etc. For instance, in response to a discovery request by discovery service 502A, consider the discovery response example below provided by node agent 503 of a node implementing a presence detection sensor (e.g., one of sensors 110), presented in a JSON format:

```
{
“comments”: “API spec for Core IPC Object ”, //internal IPC methods
“auth_token”: “rt12342d”,
“container_id”: “abcd”,
“platform_id”: “p5435”,
“conditions”: [{
  “type”: “IPC”,
  “handle to policy”: “void *ptr”,
  “IPCMethod”: “UNIX”, //example
  “IPCVersion”: “XX”,
  “registered object auth tokens”: [“t1”, “t2”,....]
  }, {
  “type”: “sensors”,
  “Devicetype”: “presence”,
  “presencetype”: “face”,
  “presence”: “engaged”,
  “attention”: “disengaged”,
  “distance”: “50cm”,
  }]
}
```

As discovery service 502A collects responses from various nodes 300, it may assemble a manifest of all devices participating in serviceability framework 400. For instance, consider a manifest example produced by discovery service 502A and presented below without specific formatting (for simplicity):

```
- System
  - IHS Information
- Orchestrator
  - INFO: ID / Info / Version / etc.
  - Device Capabilities
    - Cap_1
      - Type: Get/SET/Execute/Listen
      - Schema: details of function call
    - Cap_2,
    - Cap_3,
- Child nodes
  - Child_Dev1
    - INFO: ID / Info / Version / etc.
    - Device Capabilities
    - Child nodes
      - Child_Dev1
      - Child_dev2
  - Child_Dev2
    - ....
  - Child_Dev3
    - ....
  - Child Dev4
    - ....
```

In various embodiments, orchestrator 401 may execute discovery service 502A without any involvement by any host OS 304, OS driver, or OS agent. As such, serviceability framework 400 may operate in the absence of any host OS, or before any host OS boots (or completes its startup/wakeup processes). For instance, orchestrator 401 may execute its respective firmware to instantiate the discovery service as part of the capabilities module within framework 400. Discovery service 502A then creates a platform manifest, enumerating and loading advertised capabilities and interfaces. It proceeds to discover nodes 300 participating in framework 400 by polling devices with discovery requests or receiving broadcasted device information.

Any node 300 may collect and provide a device manifest describing any child devices coupled to it. Node 300 may create this manifest, enumerate advertised capabilities, and discover child devices by polling them or receiving their broadcast information. If there are more child devices, the process repeats; otherwise, node 300 sends its device manifest to orchestrator 401 or parent node. Orchestrator 401 adds the device manifest to the platform manifest and checks for additional child devices to discover. If more are found, the process continues; otherwise, orchestrator 401 concludes the method.

In some embodiments, these operations may be performed recursively for all parent/child devices in a hierarchical serviceability framework architecture. Each child device may gather its own child device manifest, which is sent to its respective parent device until it reaches orchestrator 401 and is added to the overall platform manifest.

Consider a situation where a user's IHS 100 is managed by an enterprise (e.g., an ITDM, an IT administrator, etc.). When the user moves IHS 100 between different workstations or workspaces, each workspace having different external and peripheral device available, at any given time an ITDM may wish to identify the user's entire workspace, including all node capabilities and interfaces. In a conventional IHS, however, typical host OS restrictions would prevent an ITDM from discovering every device or component in IHS 100. Moreover, even when a device or component is discovered, the ITDM would not have an interface available through which to access the device without going through the IHS's OS.

Using serviceability framework 400, however, an ITDM may send an inventory or manifest retrieval command or request from a remote management console application executed by a remote service(s) directly to orchestrator 401 (e.g., EC 109/215) via an OOB communication channel. Orchestrator 401 may communicate with any downstream node 300 and/or secondary orchestrator to fulfill the command or request without any interference by any host OS. For example, rather than setting an alert (e.g., a thermal alert) at the OS level, an ITDM's command, request, or policy may set the alert for a selected sensor or device directly in firmware, using capabilities 309 advertised for serviceability framework 400.

Within framework 400, capability/interface service 502B may be responsible for handling a node's capabilities and their interfaces. Particularly, capability/interface service 502B may advertise capabilities (e.g., exposed services 305), provide ‘get’ and ‘set’ interfaces or APIs (e.g., exposed interfaces 307), and advertise or otherwise distribute those capabilities/interfaces across orchestrators, nodes, and consumers. In different situations, capability/interface service 502B may be integrated into, or distinct from, discovery services 502A.

Node agent 503 may be configured to respond to a discovery request with a response that lists the exposed capabilities and interfaces of a given node. In cases where the node is a parent node, the parent's node response may list every exposed capability and interface of its child nodes. Node agent 503 may also be configured to fulfill requests and execute commands received via exposed interface 307 to reach in and out of exposed services 305. In some cases, each exposed service 305 of orchestrator 401 and/or node 300 may be surfaced as an individual capability.

When IHS 100 is powered on, discovery service 502A polls (or receives broadcasts) directly from other orchestrators or nodes with discovery information, which may include a capabilities and interfaces list, without requiring the participation of any host OS (e.g., consumer(s) 504). When capability/interface service 502B receives a node's responses through discovery service 502A, it caches a list of exposed capabilities and interfaces from that node, still without requiring the participation of any host OS. Then, capability/interface service 502B distributes the list of available capabilities to other nodes, and each node which may invoke those capabilities using their respective interfaces, in some cases subject to access controls, again without requiring the participation of any host OS.

In some cases, orchestration services 501 may implement access control mechanisms defined by a policy. For example, in some cases, a policy may provide that certain types of capabilities may be accessible to some nodes (or types of nodes) and not others. Additionally, or alternatively, these mechanisms may require certain types of node access to be performed via a selected interface, and not another interface. If two nodes have redundant capabilities exposed, for example, orchestration services 501 may select a first node to provide its capabilities to a first set of nodes or consumers, and a second node to provide its redundant capabilities to a second set of nodes or consumers, based on telemetry or contextual data.

When a node is added to framework 400 (e.g., an external device is added to a USB port, or a device finishes a firmware update and reboots, etc.), discovery service 502A may collect the node's exposed capabilities and interfaces and add them to the firmware framework manifest. Then, capability/interface service 502B may advertise or distribute those capabilities and interfaces across firmware framework 302. When the node is removed from framework 400 (e.g., an external device is unplugged, etc.), discovery service 502A may remove the node's exposed capabilities and interfaces from the platform manifest, and capability/interface service 502B may stop advertising or distributing those capabilities and interfaces across framework 400.

In some cases, with respect to capabilities exposed by a given node, policies module 308 may include access control rules based, at least in part, upon: last date of a firmware update or version of the node; a determination of whether the node is integrated into heterogeneous computing platform 200 or external to it, or whether a node is enclosed within IHS 100 or external to it; a determination of whether the node is part of a docking station, hub, or external display; the ownership of the node (e.g., user vs. enterprise); a physical or geographic location of the node; a performance configuration setting of IHS 100; a power state of IHS 100; a consumer or type of consumer (e.g., 504), or any other telemetry or contextual information described herein.

In some cases, access control mechanisms may also determine which entity within framework 400 enforces or oversees such access control. For example, in some cases, orchestration services 501 may enforce access control by selectively advertising certain capabilities/interfaces, by denying, timing out, or not forwarding commands or requests that run afoul of access control rules (e.g., because a requesting node or consumer is not authorized to make such a request), etc. The determination of which orchestrator or node enforces a given access control mechanism may be based upon any telemetry or contextual information described herein.

Additionally, or alternatively, however, access control mechanisms may operate based on AI models that receive telemetry or contextual data and determine, based upon training data, whether to provide or block certain capabilities and/or interfaces to/from specific orchestrators, nodes, and/or consumers.

If the host OS requests a node's capabilities details from orchestrator 401, capability/interface service 502B may share access to the capability with the host OS (e.g., an OS agent/driver), subject to one or more access control rules enforced by orchestration services 501 based on policy. Additionally, or alternatively, capability/interface service 502B may communicate available interfaces to the host OS for directly accessing the advertised or requested capabilities (e.g., APIs for “get” and “set” operations).

For example, consider an example of a discovery/capabilities request issued by orchestrator 401 as part of the operation of capability/interface service 502B, to a temperature sensor (e.g., one of sensors 110), as presented below in JSON format:

```
{
“auth token”: “2YotnFZFEjr1zCsicMWpAA”,
“container_id”: “abcd”,
“platform_id”: “p5435”,
{
    ″auth_token″: ″your_api_key_here″, // Replace
    with your actual authentication
  ″request_type″: ″capabilities_and_interfaces″,
  ″source_ic″: ″IC1″,
  ″destination_ic″: ″IC2″,
  ″timestamp″: ″2023-09-02T10:30:00Z″
}
```

In this example, a discovery/capabilities response sent by node agent 503 running on the temperature sensor may include its available capabilities and interfaces, as follows:

```
{
  “response_type”: “capabilities_and_interfaces”,
  “source_ic”: “IC2”,
  “destination_ic”: “IC1”,
  “timestamp”: “2023-09-02T10:35:00Z”,
  “capabilities”: [
    {
      “name”: “Temperature”,
      “description”: “Provides temperature readings in
      Celsius and Fahrenheit”,
      “interfaces”: [
        {
          “name”: “GET”,
          “description”: “Retrieve temperature readings”
        }
      ]
    },
    {
      “name”: “Thermal Limit”,
      “description”: “Allows setting a thermal limit for alerts”,
      “interfaces”: [
        {
          “name”: “SET”,
          “description”: “Set the thermal limit”
        }
      ]
    }
}
```

As such, capability/interface service 502B may be configured to handle all nodes' capabilities, and to distribute or advertise those capabilities across firmware framework orchestrators and nodes in a workspace. Ordinarily, using conventional techniques, a BIOS engineer would have to create a specific device object for each node and expose it to the host OS. In contrast, using firmware framework 307, capability/interface service 502B may make their exposed capabilities available to other devices, orchestrators, and/or consumers independently of the state of any host OS.

Moreover, these systems and methods provide the ability to insulate calling applications and node agents 503 from a node's underlying functionalities via common interface definitions agnostic of chipset, platform, line-of-business, or host OS. These systems and methods may be scalable across disparate protocols (e.g., I²C, USB, MIPI, etc.), payload types (e.g., stream/real-time, events, messages, etc.), node types (e.g., On-the-Box or “OTB” versus external devices), and/or node topology (e.g., daisy-chaining, star, mesh, etc.).

In some applications, an ITDM may wish to collect raw telemetry data from IHS 100. Conventionally, an ITDM would not be able to perform many such tasks with existing OS tools due to restrictions put in place by OS developers. Even if some telemetry data were available, there would be no scalable manner to collect, process and optimize the collection of telemetry data from IHS devices via direct connections and/or without an OS agent's assistance.

In contrast, orchestrator 401 may be configured to instantiate telemetry service 502C as part of its orchestration services 501 in framework 400. Telemetry service 502C may be responsible for enumerating and advertising telemetry capabilities, and handling telemetry settings based on defined and optimized communication paths, protocols, and/or policies. Because telemetry service 502C operates in firmware, orchestrator 401 is capable of handling telemetry operations independently of host OS 304.

Particularly, telemetry service 502C may be configured to collect all telemetry capabilities and interfaces of all orchestrators and nodes coupled to framework 400 (e.g., part of exposed services and interfaces 505 and 507). Telemetry service 502C may also be responsible for distributing telemetry capabilities and interfaces to all orchestrators and nodes.

In operation, telemetry service 502C may independently prioritize and scale communications to/from each telemetry data point, including orchestrators and nodes, to propagate the data through each node, and to deliver payload requests to a final endpoint. Meanwhile, node agent 503 may be configured to manage node 300's telemetry collection and respond to telemetry requests. Node agent 503 may collect all downstream telemetry data points advertised for child nodes with performance optimizations.

Node agent 503 may include a telemetry queue responsible for performing local orchestration operations for child nodes, as well as for configuring and/or requesting telemetry inputs from connected nodes (i.e., similarly as functions as telemetry service 502C, except telemetry service 502C is a system-wide collector/orchestrator whereas node agent 503 is a child node present as a subcomponent into telemetry service 502C's prioritization schema). Node agent 503 may also be configured to perform telemetry pass-through operations and communications with all of node 300's child nodes.

When the telemetry consumer 503 is the host OS, a secondary IHS 305, or a remote service, those consumers may include a respective service configured to initiate in-band, sideband, or OOB collection routines and obtaining telemetry data from telemetry service 502C for processing and collection.

In some cases, once a telemetry collection request is received by telemetry service 502C, telemetry service 502C may orchestrate execution of the request by identifying relevant collector node(s) (i.e., a node in charge of collecting telemetry data), aggregator node(s) (i.e., a parent node in charge of aggregating telemetry data collected by two or more child nodes), or bypass node(s) (i.e., a node that merely forwards requests and responses to upstream or downstream nodes without otherwise processing the request or response) for fulfilling the request.

How telemetry service 502C classifies a node (e.g., collector, aggregator, or bypass) may depend upon the type of telemetry collection (e.g., sensor readings, processor utilization data, etc.), the amount or size of the data being/to be collected, the available paths and protocols between nodes the power state of IHS 100, the location of IHS 100, etc.

Telemetry service 502C may maintain a list of all telemetry capabilities accessible through available interfaces. As such, telemetry service 502C may route incoming telemetry requests to appropriate collector nodes, while setting one or more of the collector nodes'parent nodes as aggregators and/or bypass nodes and/or selecting communication paths or protocols depending upon a policy. Conversely, telemetry service 502C may route outgoing telemetry responses to appropriate consumers following the policy.

Policy rules that govern telemetry collection, path and protocol selection, node classification and configuration (e.g., collector, aggregator, bypass, etc.), and other settings or options may be based upon any of the telemetry or contextual data described herein (e.g., IHS location, IHS performance or power state, current node utilization, network connection bandwidth, etc.). For example, a policy may include certain rules that apply in normal operating situations, and other rules that apply when IHS 100 is undergoing field debug operations (e.g., under control of the host OS, a secondary IHS, or a remote service).

In some applications, an OEM and/or ITDM may wish to collect debug data when there is a problem with IHS 100 in the field, and the debug data may include telemetry data (e.g., a device or component's thermal, power, performance, and/or acoustic data). Conventionally, when a technician arrives at a customer's location of IHS 100, the technician may often find restrictions on the type of telemetry data that can be retrieved from which devices or components, as well as which diagnostic tools can be executed by IHS 100, for example, due to the customer's security blocks. In those cases, the technician may have to take the IHS 100 from the user to test it at the factory or lab, which means additional costs.

However, framework 400 provides a host OS and/or silicon agnostic mechanism to collect telemetry data from selected nodes (e.g., temperature, battery charge level or rate, power state, performance state, operating frequency, cooling fan speed, sound pressure level, etc.), and to store it without interference from any host OS. The data may also be accessed directly by consumers for debug operations though orchestrator 401, still without interference from any OS. Moreover, data may be made persistent across boots, thus leading to more accurate and faster, firmware-based debug operations.

Telemetry service 502C may be configured to collect, organize, advertise, and distribute collected telemetry data from/to various nodes of framework 400. Such data may also be consumed by firmware or OS-level agents via any available interface allowed by policy. Conversely, node agent 503 may be configured to collect telemetry data from its underlying hardware device and to transmit telemetry service 502C.

The data collection by node agent 503 may be configured by policy module 308 and/or it may depend upon context information. For example, when IHS 100 is communication with an ITDM's IHS or a remote console, telemetry agent 502C may in response increase a data collection rate of node agent 503, and/or it may prioritize its telemetry traffic within interconnect 203, in some cases through alternative buses and/or protocols. When IHS 100 is disconnected from the ITDM's IHS or remote console, telemetry agent 502C may reduce the collection rate and/or it may deprioritize telemetry traffic within interconnect 203 in response thereto.

In various embodiments, when orchestrator 401 communicates with nodes 300 and/or when nodes 300 communicate among themselves, the control and/or data messages exchanged may be secured within framework 400, at least in part, through operation of security service 502D. For example, when a low-level protocol does not offer session authentication mechanisms at runtime or firmware image level integrity verification, security service 502D may add such mechanisms to framework 400 in a scalable manner across different node types, protocols, and topologies.

Although in some implementations security service 502D may be provided entirely by orchestrator 401, in other implementations orchestrator 401 may use security device 212 to execute one or more security operations (e.g., create, distribute, refresh, and void session keys, etc.) to implement aspects of security service 502D.

In some cases, security service 502D may be configured to identify when an internal or external node has been removed and/or re-programmed (e.g., with malicious or untrusted firmware). For example, security service 502D may be configured to perform node firmware image verification and inter-node communications, among other security operations.

With respect to node image verification, whenever a new node is connected to firmware framework 307, security service 502D may query the node for its firmware image details (e.g., digital certificate, signature, hash, etc.). In some cases, the digital certificate may have been specifically issued for use in firmware framework 307. Security service 502D may then perform a local verification of an image hash and/or it may also verify certificate(s) and/or signature(s) details of the node's firmware image with a cloud service (e.g., remote service 306). Upon successful verification, security service 502D may enable the node's discovery and participation in framework 400.

As to inter-node communications, consider a scenario where nodes 300B and 300C wish to communicate with each other, for example, to exchange control or data messages between them. In that case, respective node agents may reach into orchestration services 601 with a connection request, and, in response to the request, orchestration services 501 may share a session key with those node agents, and it may distribute unique cryptographic key pairs to them. In communications sent from a first node to a second node, messages by the first node may be encrypted using the first node's private key, which the second node decrypts using the first node's public key. In the reverse direction, messages sent from the second node to the first node may be encrypted using the second node's private key, which the first node decrypts using the second node's public key. After decryption, each node may verify each message for a valid session key.

In some cases, this security/encryption layer provided by security service 503C may be used in response to a determination, by discovery service 502A, that a bus/protocol used by a node to join framework 400 does not have proper native security mechanisms. In other cases, when a node's bus/protocol coupled to orchestrator 401 includes its own security mechanisms (e.g., BT) orchestrator 401 may leverage that protocol's native security mechanisms to establish and maintain secure communication channels across framework 400. In yet other cases, this security/encryption layer provided by security service 503C may be used in addition or as an alternative to a node's native security mechanisms.

Inter-node communications may also be secured by security service 503C in response to IHS 100 being coupled to an external device that can be added as an orchestrator (and/or node) in framework 400. When the external device is coupled to IHS 100, the layer of security/encryption provided by security service 503C may be added to one or more ongoing inter-node communications. When the external device is no longer coupled to IHS 100, this security/encryption may be stopped and framework 400 may rely only upon the native security mechanisms afforded by conventional buses/protocols.

If for any reason orchestration services 501 decide to pause or stop ongoing inter-node communications (e.g., based, at least in part, on any of the context information or states described herein, following contextual rule(s) prescribed by policy), security service 502D may revoke or invalidate the previously shared session key. Also, as an additional security feature, security service 502D may periodically refresh the session-key and/or cryptographic keys of the individual nodes based, at least in part, upon any context information or state described herein, also following contextual rule(s) prescribed by a policy.

Other services 502N may encompass a diverse array of services and operations. These services may include advanced diagnostics, which provide in-depth analysis of system health and performance. Predictive maintenance is another service, utilizing AI-models to forecast maintenance needs based on historical data and real-time telemetry, thereby minimizing downtime and optimizing resource allocation. Resource optimization services may dynamically adjust system operations to maximize efficiency, balancing power consumption and performance based on current usage patterns and environmental conditions. Additionally, 502N services may facilitate integration with external systems and applications, allowing the IHS to interact with a broader technological ecosystem, supporting remote management, data synchronization, and cross-platform communication.

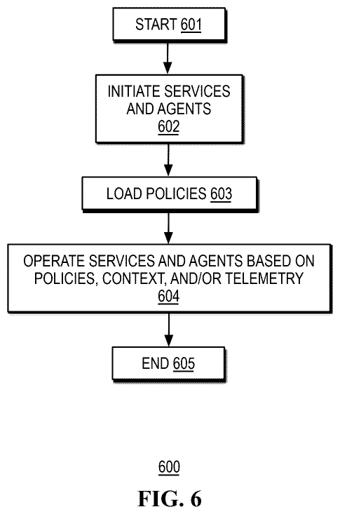

FIG. 6 illustrates a flowchart of method 600 for operating a serviceability framework. Method begins at 601. At 602, orchestrator 401 initiates orchestration services 501, while node 300 initiates node agent 503, both by executing their respective firmware instructions 302. This establishes the foundational operations of the serviceability framework, enabling the orchestrator and nodes to begin their roles in managing and coordinating the IHS's operations.

At 603, orchestrator 401 may load a policy, which serves as a set of rules and guidelines that dictate the behavior and operations of the framework. These policies enable orchestrator 402 to operate in accordance with the requirements set by users, OEMs, ITDMs, or third parties. Each policy enforced by orchestrator 401, sometimes referred to as a “serviceability policy,” may be selected to promote the efficient and adaptive operation of serviceability framework 400. A policy may include rules that are contingent upon various contextual factors, such as sensor data, IHS configuration data, device usage data, power state, performance data, thermal data, geographic location, and network metrics.

At 604, orchestrator 401 operates any orchestration service 501 or agent while enforcing the loaded policies based on context and telemetry data. This may involve dynamically adjusting system settings and operations in response to real-time data collected from sensors and other devices. Orchestrator 401 may use this data to make intelligent, contextual decisions by adapting to environmental changes and user interactions. Method 600 ends at 605, where orchestrator 401 continues to enforce policies and manage operations dynamically.

This context-driven approach allows OEMs and ITDMs to implement a wide range of intelligent productivity, service, security, and value-added features within serviceability framework 400. These features may be tailored to optimize IHS performance, enhance user experience, and provide robust security measures. A serviceability policy enables orchestrator 401 to make real-time decisions that adapt to changing conditions, such as adjusting power management settings based on battery state or modifying network configurations in response to bandwidth availability.

In some applications, certain IHS operations may rely upon interactions between two or more devices or components. For example, in certain situations, sensors 110 may include an Ambient Light Sensor (ALS), and the brightness of display 111 may be automatically adjusted in response to changes in ambient light. In other situations, an IHS's cooling fans may be configured to respond to a display's current resolution, color depth, or frame rate.

In a conventional IHS, EC 109/215 would require one or more custom sideband GPIOs and/or host OS agents to discover these devices and to enable communications between them. In contrast, orchestrator 401 may discover participating nodes directly, via firmware, and without interference or participation from any host OS or dedicated GPIOs.

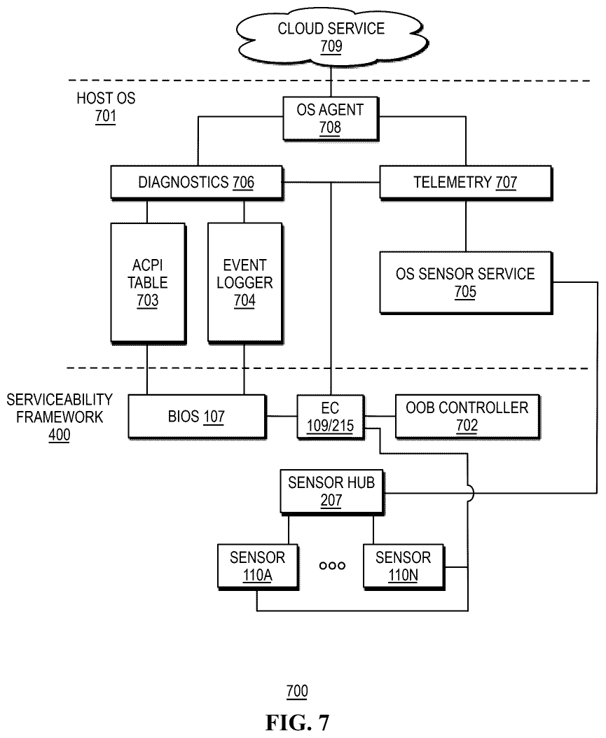

FIG. 7 illustrates a diagram of an example contextual intelligence system 700. In this embodiment, system 700 includes the serviceability framework 400, host OS 701, and remote or cloud service 709.

Serviceability framework 400 includes EC 109/215 operating as orchestrator 401. Orchestrator 401 is coupled to BIOS 107, Out-of-Band (OOB) controller 702, and sensor hub 207. Sensor hub 207 is connected to a variety of sensors 110A-N, which provide real-time data on environmental conditions and user interactions. EC 109/215 is also coupled to sensors 110A-N, allowing it to manage and coordinate their operations directly. Each of OOB controller 702, sensor hub 207, and sensors 110A-N may instantiate a respective node within framework 400, making them discoverable by orchestrator 401.

OOB controller 702 enables remote management and monitoring of the IHS 100, even when host OS 701 is inactive or the IHS is powered down. It facilitates communication with external management systems, allowing tasks such as firmware updates, diagnostics, and configuration changes to be performed by EC 109/215, operating as orchestrator 401, and without relying on host OS 701.

Within host OS 701, BIOS 107 communicates with diagnostics module 706 using Advanced Configuration and Power Interface (ACPI) tables 703 and event logger 704. ACPI tables 703 serve as a standardized interface for conveying system configuration and power management information, enabling host OS 701 to access and interpret data regarding IHS components and operational states. Event logger 704 records system events and performance metrics, providing a detailed log of activities and changes within the IHS. The logging mechanism allows diagnostics and performance data to be accurately captured and analyzed, facilitating effective monitoring and troubleshooting. Additionally, this allows orchestrator 401 to communicate with host OS 701 through BIOS 107, for seamless integration and coordination between serviceability framework 400 and host OS 701.

OS sensor service 705 is coupled to sensor hub 207 and telemetry module 707, providing a pathway for sensor data to be received and processed directly by host OS 701, in some cases, without interference from orchestrator 401. EC 109/215 and OS agent 708 may be connected to diagnostics module 706 and telemetry module 707, enabling monitoring and response to various operational states and conditions.

OS agent 708 is also coupled to cloud service 709 to provide remote management and data synchronization. This allows for the integration of cloud-based resources and services, providing additional layers of intelligence and adaptability to system 700.

In various embodiments, system 700 may be configured to perform a wide range of operations that enhance the overall efficiency and adaptability of an IHS. Particularly, contextual awareness may be achieved by leveraging data from a comprehensive array of sensors. These sensors enable system 700 to intelligently detect user presence, environmental conditions, usage patterns, etc. Such capability allows for proactive adjustments to IHS settings, such as display brightness, audio responsiveness, power management, and so on.

Orchestrator 401 may perform dynamic policy enforcement. It enforces policies based on contextual factors, resulting in intelligent productivity, service, security, and value-added features without relying on host OS 701. As a result, system 700 operates efficiently and responsively, adapting to real-time changes in its environment and maintaining optimal functionality.

In some cases, system 700 may provide self-healing and remediation capabilities, allowing it to automatically detect and resolve issues. This improves reliability and reduces maintenance costs, often without requiring user intervention. Furthermore, system 700's connection to cloud services 709 enables remote management tasks, data synchronization, and the integration of external resources, providing additional layers of intelligence and adaptability, allowing the IHS to respond to changing demands and user needs.

In today's technological landscape, IHSs are increasingly relied upon for both personal and professional tasks. These devices are equipped with sophisticated hardware and software components designed to deliver high performance, reliability, and user convenience. However, the portability and complexity of such devices expose them to various environmental, physical, and operational challenges, such as sudden impacts, free-fall events, high-G shocks, environmental conditions, hardware or sensor failures, power-related issues, security threats, and user interaction anomalies. These events often compromise functionality, data integrity, and system security, leading to significant disruptions in productivity, increased repair costs, and potential data loss.

Existing solutions for managing the aftermath of such events in IHSs are limited in scope and effectiveness. Conventional systems often rely on host OSs to monitor and respond to system conditions. While OS-based approaches provide some level of adaptability, they are fundamentally constrained in their ability to address significant issues when the OS is inactive, corrupted, inoperable, or absent. For example, current systems lack mechanisms to detect and respond to high-impact collisions, free-fall events, or environmental conditions such as extreme temperatures, humidity, or dust accumulation in real-time, leaving devices vulnerable to catastrophic failures. Furthermore, these systems fail to provide proactive measures to safeguard important components, such as the motherboard, firmware, and storage devices, during or after such events.

Another disadvantage of conventional IHSs is their inability to enforce access control or configuration restrictions at the firmware level in response to various types of events. Conventional IHSs often allow unrestricted access to BIOS setup and configuration settings, even after critical events such as hardware failures, power-related issues, or security threats have occurred. This unrestricted access can lead to inadvertent writes to NVRAM or other firmware components, increasing the risk of corruption and further compromising stability. Additionally, traditional IHSs lack mechanisms to assess the health of important components before allowing configuration changes, leaving users unaware of potential underlying issues that may require remediation.

To address these, and other concerns, systems and methods described herein may be configured to manage BIOS configuration settings and/or the availability thereof to users in the aftermath of sensor-detected events, including impact, environmental conditions, hardware or sensor failures, power-related issues, security threats, user interaction anomalies, etc.

As used herein, the term “BIOS configuration setting” or “BIOS setting” generally refers to a set of options or parameters within BIOS 107 that control the behavior, functionality, and performance of hardware and firmware components in the IHS. These settings allow users to customize and optimize various aspects of the IHS, including performance, security, and compatibility. For example, BIOS configuration settings may include system performance options, such as enabling or disabling processor cores, adjusting CPU clock speeds, configuring memory timings and frequencies, or enabling power-saving features like INTEL SpeedStep or AMD Cool'n'Quiet.

Storage-related settings may include configuring the boot order, selecting RAID or SATA modes (e.g., AHCI, IDE, or RAID), enabling secure boot to ensure only trusted software loads during startup, or setting passwords for hard drives to enhance security. Peripheral and I/O settings may include enabling or disabling USB ports, configuring Thunderbolt security levels, or adjusting PCIe lane allocation. Security-related settings may include setting administrator or user passwords to restrict access to BIOS 107, enabling or disabling a Trusted Platform Module (TPM) for hardware-based encryption, or configuring Intel Management Engine BIOS Extension (MEBX) settings for remote management.

Additionally, BIOS configuration settings may include system monitoring options, such as configuring fan speed profiles, setting temperature thresholds for thermal management, or enabling event logging for hardware diagnostics. Advanced settings may include enabling virtualization technologies (e.g., Intel VT-x or AMD-V), selecting integrated or discrete GPUs for display output, or configuring network boot options such as PXE. Miscellaneous settings may include setting the system time and date, enabling firmware updates, or configuring posture detection for convertible devices.

In various embodiments, orchestrator 401 may be configured to monitor and detect system events in real-time. Upon detection, orchestrator 401 may communicate with BIOS 107 (e.g., using a mailbox technique or the like) to enforce access control restrictions, safeguarding selected components and preventing unauthorized or inadvertent writes to firmware or storage devices. BIOS 107 may be placed into a restricted mode, allowing only read operations or reduced functionality until the IHS's health is assessed and verified.

As used herein, the terms “system event,” “service event,” and “event” refer to a specific occurrence or condition detected by an IHS that requires action, notification, or intervention for purposes of performance, security, or reliability. These events may be identified through telemetry data, contextual data, or sensor inputs and are managed by orchestrator 401 within serviceability framework.

Examples of service events include environmental conditions such as extreme ambient temperatures, high humidity or moisture levels, dust accumulation near inlets or vents, and air quality issues detected through particle sensors. Physical impact, such as high G-shock events, free-fall detection, or system motion during transit, also constitute service events. Additionally, changes in IHS state, such as detecting that the system is in a bag, geographic location changes, or high system usage or resource utilization, may trigger service events. Hardware or sensor failures, including fan sensor or thermal sensor malfunctions, are further examples of service events.

Power and battery-related conditions, such as low battery levels, activation of overcurrent protection mechanisms, or transitions between power sources, may also be classified as service events. Security or configuration issues, such as unauthorized BIOS configuration changes, detection of unmanaged software installations or updates, or attempts to access restricted ports or peripherals, are additional examples. Furthermore, user interaction or presence, including user proximity, engagement levels, or input activity, may also be identified as service events.

When a service event is detected, orchestrator 401 may take specific actions to address it. These corrective or responsive actions may include sending notifications to BIOS 107 to enforce access control restrictions, safeguard critical components, and/or adjust system settings based (e.g., a registry) on the nature of the event and/or context. For example, orchestrator 401 may instruct BIOS 107 to restrict configuration changes by placing the BIOS setup UI/UX into a read-only mode or reduced functionality, preventing inadvertent writes to non-volatile memory (NVRAM) or other firmware components.

These systems and methods also include mechanisms for performing health scans on significant motherboard components, to verify that baseline thresholds are met before lifting BIOS configuration restrictions. If the health scan results indicate that the IHS is compromised, BIOS 107 may prompt the user to contact technical support or display a QR code for further assistance. Additionally, orchestrator 401 may respond to environmental conditions such as extreme temperatures, humidity, or dust accumulation by dynamically adjusting system settings, restricting operations, or notifying remote management systems (e.g., using OOB controller 702).

For power-related issues, such as low battery levels or transitions between power sources, orchestrator 401 may enforce corrective actions, such as limiting performance or restricting charging. Security threats, such as unauthorized BIOS access or attempts to access restricted ports, may trigger immediate protective measures, including locking drives, restricting boot processes, or disabling specific features. User interaction anomalies, such as in-bag detection or high motion detection, may prompt the system to enter hibernation mode or notify IT administrators through OOB communications.

Consider, for example, a situation where an IHS experiences a shock event, such as a high-G impact or free-fall detection. In this scenario, orchestrator 401 may detect the event through integrated sensors 110A-N and/or sensor hub 207 and send a notification to BIOS 107 via a mailbox command. The BIOS, in response, may enforce access control restrictions by placing the BIOS setup into a read-only mode or reduced functionality. This may prevent any inadvertent writes to NVRAM or other firmware components. A health scan may then be performed on selected motherboard components to verify their integrity. If the health scan satisfies baseline thresholds, orchestrator 401 may send a command to lift the restrictions, allowing the user to make configuration changes. If the health scan indicates compromised system integrity, BIOS 107 may prompt the user to contact IT support or display a QR code for further assistance.

Following the shock event, a user may reboot the IHS and attempt to configure settings such as the battery profile or Thunderbolt configurations in the BIOS setup. These changes often involve writes to firmware or storage devices, which can exacerbate system instability if the health of critical components has been compromised. Here, however, orchestrator 401 has previously detected the event and sent the notification to the BIOS, which placed the BIOS setup into a restricted mode. Accordingly, upon boot up, a health scan may be initiated to assess the integrity of the motherboard and other components. If the health scan results meet baseline thresholds, orchestrator 401 may send a command to lift the restrictions.

In another scenario, a user may attempt to access Intel's Management Engine BIOS Extension (MEBX) or third-party device configuration interfaces, such as Intel's Converged Security and Management Engine (CSME), after the IHS detects a security threat, such as unauthorized BIOS access or an attempt to install unmanaged software. These interfaces often involve critical writes to firmware or storage devices, which could compromise system security if the threat is not mitigated. Using the systems and methods described herein, orchestrator 401 may detect the security threat and send a notification to the BIOS, which enforces restrictions on configuration changes within these interfaces. The BIOS setup may be placed into a secure mode, disabling certain features. Concurrently, orchestrator 401 may initiate a security validation process, such as verifying firmware integrity or checking for unauthorized modifications. If the validation process confirms the IHS's security, orchestrator 401 may send a command to lift the restrictions.

In yet another scenario, the IHS may detect adverse environmental conditions, such as extreme ambient temperatures or high humidity levels, during which a user may attempt to change hard drive configurations, such as RAID/SATA mode, or install a new password on the hard drive. These operations may involve writes to firmware or storage devices, which could exacerbate system instability if the environmental conditions are not addressed. To address this, orchestrator 401 may detect the environmental conditions and notify BIOS 107, which enforces restrictions on configuration changes by placing the BIOS setup into a restricted mode. Orchestrator 401 may dynamically adjust IHS settings, such as reducing power to sensitive components or entering a low-performance mode, to mitigate the impact of the environmental conditions. Once the sensors confirm that the environmental conditions have returned to safe levels, orchestrator 401 may send a command to lift the restrictions, allowing the user to proceed with the desired changes. If the conditions persist BIOS 107 may continue to restrict configuration changes and notify the user or IT administrators through OOB communications, recommending further actions such as relocating the device or cleaning air inlets.

In various embodiments, systems and method described herein enable orchestrator 401 to dynamically control and manage access to BIOS configuration settings in response to service events. As such, these systems and methods introduce a safeguard mechanism that restricts write operations to storage devices and BIOS configurations when events happen, thereby reducing the risk of significant failures in the motherboard and associated components. Orchestrator 401 may actively monitor such events and communicate with the BIOS to enforce write restrictions, for example, based on a BIOS management policy.

BIOS 107 may then perform a motherboard health scan to assess components against baseline thresholds. If the health scan satisfies the thresholds, orchestrator 401 may lift the restriction, allowing the user to modify BIOS configurations; otherwise, the IHS may prompt the user to seek technical assistance, send a notification to an ITDM and/or OEM, and/or display a QR code for further guidance, thus proactively addressing potential hardware failures.

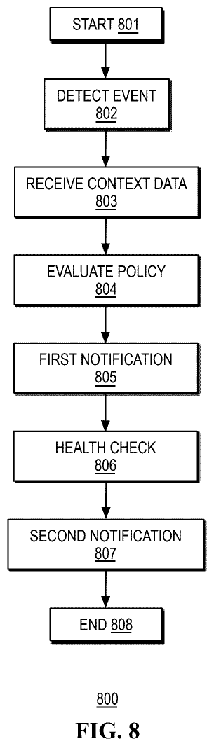

To illustrate this, FIG. 8 shows an example of method 800 for BIOS management. In various embodiments, operations shown in method 800 may be performed, at least in part, by orchestrator 401. Particularly, method 800 begins at 801.

At 802, orchestrator 401 may detect an event that may impact system performance, security, or stability. These events may include environmental conditions (e.g., extreme ambient temperatures, high humidity, moisture, air quality, or dust accumulation), physical impacts (e.g., high-G shock events or free-fall detection), system state changes (e.g., in-bag detection, geographic location changes, posture changes, or power state transitions), hardware or sensor failures (e.g., fan sensor or thermal sensor malfunctions), power-related conditions (e.g., low battery levels or transitions between power sources), security threats (e.g., unauthorized BIOS access or attempts to access restricted ports), or user interaction anomalies (e.g., user presence, proximity, or engagement levels). These events may be detected through telemetry data collected directly from sensors 110A-N or aggregated by sensor hub 207.

At 803, orchestrator 401 may receive context data related to the detected event. Context data may include information such as user presence, geographic location, IHS posture, environmental exposure metrics, or system usage patterns. This data may provide additional insights into the operational environment and circumstances surrounding the event, enabling the orchestrator to make intelligent, contextually aware decisions.

At 804, orchestrator 401 may evaluate a BIOS management policy to determine the appropriate response to the detected event and context data. The BIOS management policy includes a set of context-based rules that prescribe actions based on the type of event and the surrounding context. For example, the policy may specify different BIOS write restrictions for the same event under varying contexts, such as restricting all configuration changes during a high-G shock event when the IHS is in transit versus allowing limited changes when the IHS is stationary. Similarly, the policy may prescribe different actions for the same context under varying events, such as restricting power-related settings during low battery conditions versus restricting security-related settings during unauthorized BIOS access. These rules enable the orchestrator to dynamically adapt its response to the specific circumstances of the event and context, as described in more detail below.

At 805, orchestrator 401 may send a notification to BIOS 107, instructing it to enforce specific configuration restrictions based on the evaluated policy. The notification may indicate which BIOS configuration settings should be restricted, such as disabling writes to NVRAM, locking access to certain interfaces, or placing the BIOS setup into a read-only mode. Additionally, the notification may include contextual information, such as the type of event, the severity of the impact, or the surrounding environmental conditions, to guide BIOS 107 in implementing the restrictions.

At 806, BIOS 107 and/or orchestrator 401 may perform a component health check to assess the integrity of critical system components, such as the motherboard, storage devices, or sensors. This health check may involve diagnostics operations, such as verifying firmware integrity, checking for hardware malfunctions, or evaluating baseline thresholds for system performance and stability. The results of the health check may provide a comprehensive assessment of the system's condition following the detected event.

At 807, the results of the health check may be communicated to BIOS 107 in the form of a second notification. This notification may instruct BIOS 107 to remove the previously enforced restrictions if the health check satisfies baseline thresholds, allowing the user to proceed with configuration changes. Alternatively, the notification may add additional restrictions if the health check reveals compromised system integrity. In some cases, BIOS 107 may prompt the user to contact IT support or display a QR code for further assistance, providing a pathway for remediation. Method 800 ends at step 808, where the orchestrator continues to monitor the system for new events and context changes, dynamically enforcing policies and managing BIOS configuration settings as needed.

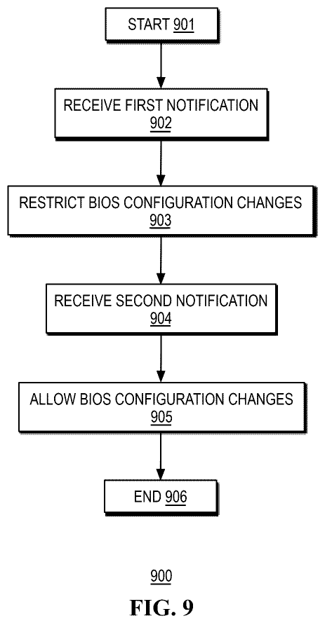

FIG. 9 shows an example of method 900 for BIOS management. In various embodiments, operations shown in method 900 may be performed, at least in part, by orchestrator 401. Particularly, method 900 begins at 901, where the system is powered on or rebooted, initiating the orchestrator's operations and enabling communication with BIOS 107.

At 902, BIOS 107 may receive a first notification from orchestrator 401, which may have been transmitted during operation 805 in FIG. 8. This notification may provide instructions to BIOS 107 regarding which configuration settings to restrict based on the detected event and evaluated BIOS management policy. For example, the notification may specify that certain settings, such as RAID/SATA mode, CPU clock speeds, or secure boot configurations, should be restricted. The notification may also include contextual information, such as the severity of the event, the type of restriction to enforce (e.g., read-only mode or reduced functionality), and the duration of the restriction (e.g., for the current boot cycle, until further notice, or permanently unless overridden by another notification). This provides BIOS 107 guidance on how to safeguard critical system components and prevent inadvertent writes to firmware or storage devices.

At 903, BIOS 107 may enforce the restrictions specified in the first notification by modifying the user interface/user experience (UI/UX) of the BIOS setup. Specifically, BIOS 107 may gray out or disable access to the affected configuration settings, making them unresponsive to user input. Non-affected settings may remain accessible and modifiable, allowing the user to make changes that do not pose a risk to system stability or security. For example, if orchestrator 401 instructs BIOS 107 to restrict changes to power management settings due to a detected low battery condition, the user may still be able to modify unrelated settings, such as system time and date.

At 904, BIOS 107 may receive a second notification from orchestrator 401, which may be transmitted as a result of operation 807 in FIG. 8. This second notification may provide updated instructions based on the results of a component health check or changes in the system's context. For example, if the health check confirms that the motherboard and other critical components meet baseline thresholds, as defined in the policy, the second notification may instruct BIOS 107 to lift the previously enforced restrictions, allowing the user to access and modify the affected settings.

Conversely, if the health check reveals compromised system integrity or if the detected event persists (e.g., extreme environmental conditions), the second notification may instruct BIOS 107 to maintain or even expand the restrictions. In some cases, the second notification may prompt BIOS 107 to display a message to the user, such as a recommendation to contact IT support or a QR code for further assistance.

Method 900 ends at 906, where BIOS 107 continues to operate in accordance with the instructions provided by orchestrator 401. In some implementations, orchestrator 401 may remain active, monitoring the system for new events and context changes, and dynamically issuing notifications to BIOS 107 as needed.

In various embodiments, a BIOS management policy, as described herein, may include a set of context-based rules that govern how orchestrator 401 interacts with BIOS 107 to enforce restrictions and/or manage configuration settings in response to detected events. This policy may be designed to dynamically adapt to various types of events and contextual data, ensuring that the IHS remains secure, operational, and optimized under different conditions. The policy may prescribe actions based on the type of event, such as physical impacts, environmental conditions, hardware or sensor failures, power-related issues, security threats, or user interaction anomalies. It may also account for contextual factors, such as user presence, geographic location, system posture, environmental exposure metrics, or system usage patterns, to tailor its response to the specific circumstances surrounding the event.

For example, the BIOS management policy may specify different restrictions for the same event under varying contexts. During a high-G shock event, the policy may restrict all configuration changes if the system is in transit, whereas it may allow limited changes if the system is stationary. Similarly, the policy may prescribe different actions for the same context under varying events. For instance, it may restrict power-related settings during low battery conditions but prioritize security-related restrictions during unauthorized BIOS access. These rules enable orchestrator 401 to intelligently adapt its response.

The BIOS management policy may enforce a wide range of corrective actions, such as disabling writes to non-volatile memory (NVRAM), locking access to specific interfaces, placing the BIOS setup into a read-only mode, or restricting access to certain configuration settings. It may also specify the duration of these restrictions, such as applying them for the current boot cycle, until further notice, or permanently unless overridden by another notification. Additionally, the policy may guide orchestrator 401 in determining which settings to restrict based on the severity of the event, the health of selected components, or the surrounding environmental conditions. For example, during extreme ambient temperatures, the policy may restrict changes to thermal management settings and dynamically adjust system performance to prevent overheating.

The policy may also enable proactive measures, such as initiating health scans of the motherboard and other critical components to assess integrity. Based on the results of these scans, the policy may instruct orchestrator 401 to lift restrictions, add more restrictions, or prompt the user to contact IT support. In some cases, the policy may include provisions for notifying IT administrators or remote management systems through OOB communications, allowing for timely interventions and remediation. For instance, if the system detects high humidity levels, the policy may recommend cleaning air inlets or relocating the device to a safer environment.

Consider, for example, a situation where orchestrator 401 detects a low battery level while operating on battery power. The user may be actively working on the device in a stationary environment, and the BIOS management policy may be triggered to restrict changes to power management settings, such as disabling the ability to adjust CPU performance modes or battery charging profiles, to prevent further strain on the battery. Other settings, such as time and date, may remain accessible to minimize disruption to the user experience. Orchestrator 401 may send a notification to BIOS 107 to enforce these restrictions, so that critical power-related settings are safeguarded. Once the battery level is restored to a safe threshold, orchestrator 401 may send a second notification to lift the restrictions, allowing the user to modify power management settings as needed.

In another scenario, orchestrator 401 may detect a significant geographic location change, such as moving from a secure office environment to a public space. The user may be connected to an unsecured Wi-Fi network in the new location, triggering the BIOS management policy to restrict changes to security-related settings. For example, the policy may disable the ability to modify secure boot configurations or TPM settings to prevent unauthorized access or tampering in the less secure environment. Orchestrator 401 may send a notification to BIOS 107 to enforce these restrictions, placing the BIOS setup into a secure mode with limited functionality. Once orchestrator 401 detects a return to a secure location, it may send a second notification to lift the restrictions, enabling the user to access and modify security settings.

In yet another scenario, sensors may detect significant dust accumulation near air inlets and vents, potentially impacting cooling performance. The IHS may be operating in a high-performance mode with elevated CPU and GPU usage, and the BIOS management policy may be triggered to restrict changes to thermal management settings, such as fan speed profiles or temperature thresholds, to prevent overheating. Additionally, the policy may dynamically reduce system performance to mitigate the impact of reduced cooling efficiency. Orchestrator 401 may send a notification to BIOS 107 to enforce these restrictions and adjust system performance. The BIOS setup may remain in reduced functionality mode until the dust accumulation is addressed. The user may be notified to clean the air inlets, and once sensors confirm improved airflow, orchestrator 401 may send a second notification to lift the restrictions, restoring functionality.

In another scenario, sensors may detect that the IHS is inside a bag during the boot process. The user may be traveling, and the system may be powered on while enclosed in a confined space, triggering the BIOS management policy to restrict changes to display-related settings, such as brightness or resolution, to prevent overheating due to the lack of ventilation. Additionally, the policy may place the IHS into a low-power mode to minimize heat generation. Orchestrator 401 may send a notification to BIOS 107 to enforce these restrictions. The BIOS setup may remain in reduced functionality mode until sensors confirm that the IHS is removed from the bag. Once the IHS is in a safe operating environment, orchestrator 401 may send a second notification to lift the restrictions, allowing the user to access and modify display settings.

In yet another scenario, sensors may detect that the user is physically present but disengaged, such as sitting near the device without interacting with it. The IHS may be idle, and the BIOS management policy may be triggered to restrict changes to peripheral settings, such as disabling the ability to modify USB port configurations or PCIe device allocations, to prevent unauthorized access while the user is disengaged. The policy may also lock certain BIOS settings to ensure security during idle periods. Orchestrator 401 may send a notification to BIOS 107 to enforce these restrictions, locking the BIOS setup. Once sensors detect active user engagement, such as keyboard or mouse input, orchestrator 401 may send a second notification to lift the restrictions, allowing the user to access and modify peripheral settings.

In another case, orchestrator 401 may detect an overcurrent protection event triggered by a peripheral device drawing excessive power. The user may be attempting to connect multiple high-power peripherals, such as external GPUs and storage devices, simultaneously, triggering the BIOS management policy to restrict changes to power delivery settings. For example, the policy may disable the ability to modify USB power limits or PCIe power allocation to prevent further strain on the system's power supply. Additionally, the policy may disable certain high-power peripherals. Orchestrator 401 may send a notification to BIOS 107 to enforce these restrictions and disable affected peripherals. The BIOS setup may remain in restricted mode until the overcurrent condition is resolved. Once the system detects normal power levels, orchestrator 401 may send a second notification to lift the restrictions, allowing the user to reconnect and configure peripherals safely.

In yet another case where orchestrator 401 detects persistent high ambient temperatures, the BIOS management policy may be triggered to restrict certain configuration changes to prevent overheating and safeguard critical components. Initially, orchestrator 401 may send a first notification to BIOS 107, instructing it to enforce restrictions on thermal management settings, such as disabling changes to fan speed profiles or temperature thresholds. The BIOS setup may be placed into a reduced functionality mode, allowing only limited access to non-critical settings. Concurrently, orchestrator 401 may initiate a health scan to assess the system's thermal performance and the integrity of temperature-sensitive components.

At this stage, orchestrator 401 may continue to monitor the environmental conditions. If the sensors detect that the high temperature persists or worsens, orchestrator 401 may send a second notification to BIOS 107, adding further restrictions to protect the IHS. For example, the second notification may instruct BIOS 107 to disable access to additional settings, such as CPU performance modes or GPU configurations, and dynamically reduce system performance to reduce heat generation. BIOS 107 may also lock access to certain advanced settings, such as overclocking options, to prevent the user from inadvertently exacerbating the thermal issue. Additionally, BIOS 107 may display a warning message to the user, recommending immediate action, such as relocating the device to a cooler environment or shutting down non-essential applications.

These added restrictions may remain in place until sensors confirm that the ambient temperature has returned to safe levels. Once the environmental conditions stabilize, orchestrator 401 may send a third notification to BIOS 107, lifting the restrictions and restoring functionality.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a controller having firmware that, upon execution by a processing core, causes the processing core to instantiate an orchestrator of a serviceability framework; and
a plurality of devices coupled to the controller, wherein each device of the plurality of devices comprises firmware that, upon execution by a corresponding processing core, causes the corresponding processing core to produce a node coupled to the orchestrator via the serviceability framework, and wherein the orchestrator is configured to:
detect an event; and
in response to the detection, provide a notification to a Basic Input/Output System (BIOS), wherein the BIOS is configured to restrict a change to a BIOS configuration setting in response to the notification.

2. The IHS of claim 1, wherein the controller comprises an Embedded Controller (EC) or Baseband Management Controller (BMC).

3. The IHS of claim 1, wherein the plurality of devices comprises at least one of: a sensor, a sensor hub, a Central Processing Unit (CPU), a Graphical Processing Unit (GPU), an audio Digital Signal Processor (aDSP), a Neural Processing Unit (NPU), a Tensor Processing Unit (TPU), a Neural Network Processor (NNP), an Intelligence Processing Unit (IPU), an Image Signal Processor (ISP), a Video Processing Unit (VPU), a camera controller, an audio controller, a memory, a Universal Serial Bus (USB) device, a Peripheral Component Interconnect express (PCIe) device, or a Trusted Platform Module (TPM).

4. The IHS of claim 1, wherein at least one of the plurality of devices is coupled to the controller via at least one of: a Systems-on-Chip (SoC) interconnect, a Peripheral Component Interconnect express (PCIe) bus, or a Universal Serial Bus (USB) port.

5. The IHS of claim 4, wherein the SoC interconnect comprises at least one of: an Advanced Microcontroller Bus Architecture (AMBA) bus, a QuickPath Interconnect (QPI) bus, or a HyperTransport (HT) bus.

6. The IHS of claim 1, wherein the event comprises at least one of: an environmental condition, a physical impact, a state change, a hardware or sensor failure, a power or battery-related condition, a security issue, or a user interaction.

7. The IHS of claim 6, wherein the environmental condition comprises at least one of: ambient temperature, humidity, moisture, air quality, dust accumulation, or light level.

8. The IHS of claim 6, wherein the state change indicates at least one of: in-bag detection, geographic location change, high system usage, motion or vibration detection, power state transition, peripheral or port change, or posture change.

9. The IHS of claim 6, wherein the battery-related condition indicates at least one of: low battery level, overcurrent protection activation, battery charge cycle count, battery state of health, battery temperature, or a transition between power sources.

10. The IHS of claim 6, wherein the security issue indicates at least one of: detection of unauthorized BIOS access, detection of an unmanaged software installation or update, or an attempt to access restricted ports or peripherals.

11. The IHS of claim 1, wherein to detect the event, the orchestrator is configured to evaluate telemetry or contextual data from at least one of: a sensor or a sensor hub, among the plurality of devices via the serviceability framework.

12. The IHS of claim 1, wherein the orchestrator is configured to provide the notification while a host OS of the IHS is: in a sleep state, in a standby state, corrupted, inoperable, or absent.

13. The IHS of claim 1, wherein the orchestrator is configured to provide the notification based, at least in part, upon enforcement of a BIOS management policy.

14. The IHS of claim 13, wherein the BIOS management policy comprises one or more context-based rules that enable the orchestrator to determine whether to provide the notification based, at least in part, upon contextual data.

15. The IHS of claim 13, wherein the BIOS management policy comprises one or more context-based rules that enable the orchestrator to include in the notification a selection of a BIOS configuration setting to be protected based, at least in part, upon the event.

16. The IHS of claim 13, wherein the BIOS management policy comprises one or more context-based rules that enable the orchestrator to include in the notification a selection of a BIOS configuration setting to be protected based, at least in part, upon contextual information.

17. The IHS of claim 16, wherein the contextual information comprises at least one of: user presence or geographic location.

18. The IHS of claim 16, wherein the orchestrator is configured to:
determine a health metric of the IHS; and
in response the determination, provide another notification to the BIOS to allow changes to the configuration setting.

19. A method, comprising:
receiving a notification at a Basic Input/Output System (BIOS) from an Embedded Controller (EC) of an Information Handling System (IHS); and
in response to the notification, restricting a user's ability to change to a BIOS configuration setting.

20. An Embedded Controller (EC) integrated into or coupled to a heterogeneous computing platform of an Information Handling System (IHS), the EC comprising:
a processing core distinct from any host processor of the heterogeneous computing platform; and
a memory coupled to the processing core, the memory having firmware instructions stored thereon that, upon execution by the processing core, cause the EC to provide a notification to a Basic Input/Output System (BIOS) in response to an event, wherein the BIOS is configured to restrict a change to a BIOS configuration setting in response to the notification.
